(19) United States
(12) Patent Application Publication
(10) Pub. No.: US 2018/0260218 A1
(43) Pub. Date: Sep. 13, 2018

(54) INSTRUCTION SET ARCHITECTURES FOR FINE-GRAINED HETEROGENEOUS PROCESSING

(71) Applicant: Vinodh Gopal, Westborough, MA (US)

(72) Inventor: Vinodh Gopal, Westborough, MA (US)

(21) Appl. No.: 15/452,150

(22) Filed: Mar. 7, 2017

(51) Int. Cl. G06F 9/26; G06F 9/30; G06F 9/345

(52) U.S. Cl. CPC G06F 9/268; G06F 9/345; G06F 9/30058

(57) ABSTRACT

Instruction set architectures (ISA) for fine-grained heterogeneous processing and associated processors, methods, and compilers. The ISA includes instructions that are configured to be executed on processors having heterogeneous cores implementing different micro-architectures. Mechanisms are provided to enable respective code segments to be compiled/assembled for a target processor (or processor family) with heterogeneous cores and have appropriate code segments that has been compiled for specific types of processor core micro-architectures be dynamically called at run-time via execution of the ISA instructions. The ISA instructions include both unconditional and conditional branch and call instructions, in addition to instructions that support processors with three or more different types of cores. The instructions are configured to support dynamic migration of instruction threads across heterogeneous cores while adding substantially no overhead. A compiler is also provided to generate and assemble opcode segments configured to be executed on processors with heterogeneous cores.

### BACKGROUND INFORMATION

Increases in processor speeds, memory, storage, and network bandwidth technologies have resulted in the build-out and deployment of networks with ever increasing capacities. More recently, the introduction of cloud-based services, such as those provided by Amazon (e.g., Amazon Elastic Compute Cloud (EC2) and Simple Storage Service (S3)) and Microsoft (e.g., Azure and Office 365) has resulted in additional network build-out for public network infrastructure, in addition to the deployment of massive data centers to support these services that employ private network infrastructure.

Cloud-based services are generally facilitated by a large number of interconnected high-speed servers, with host facilities commonly referred to as server “farms” or data centers. These server farms and data centers generally comprise a large-to-massive array of rack and/or blade servers housed in specially-designed facilities. Many of the larger cloud-based services are hosted via multiple data centers that are distributed across a geographical area, or even globally. For example, Microsoft Azure has multiple very large data centers in each of the United States, Europe, and Asia. Amazon employs co-located and separate data centers for hosting its EC2 and AWS services, including over a dozen AWS data centers in the US alone.

One of limiting factors in data center performance is thermal loading, at both the individual processor level and the rack level. Thermal loading is directly related to processor power consumption: the more power a processor consumes, the more heat it generates. As processor densities increase (i.e., more processors within a given physical space in a rack, thermal considerations have become ever more important. Today, there are various approaches for balancing performance and thermal loading, including distributing workloads across more processors, and putting cores into reduced power states. However, both of these are coarse-grained approaches.

Recently, heterogeneous processor architectures employing a mixture of “big” cores and “little” cores have been introduced. The processors have been primarily targeted towards low-power client/mobile devices, but it is envisioned that server processors with heterogeneous architectures will provide enhanced performance through more efficient processor utilization.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a is a diagram an Arm processor with identically-sized clusters of “Big” and “Little” cores and configured to implement a clustered switching scheme;

FIG. 1b is a diagram of an in-kernel switcher scheme under which pairs of Big and Little cores are implemented as virtual cores;

FIG. 1c is a diagram of an Arm processor with Big and Little cores that employs a heterogeneous multi-processing (global task scheduling) scheme under which, concurrent use of all cores is enabled;

FIGS. 2a and 2b respectively illustrate pseudocode listings corresponding to embodiments of unconditional and conditional branch instructions that employ operands with IP offsets;

FIGS. 3a and 3b respectively illustrate pseudocode listings corresponding to embodiments of unconditional and conditional call instructions that employ operands with IP offsets;

FIGS. 4a and 4b respectively illustrate pseudocode listings corresponding to embodiments of unconditional and conditional branch instructions that employ operands with addresses of opcode segments to branch execution to;

FIGS. 5a and 5b respectively illustrate pseudocode listings corresponding to embodiments of unconditional and conditional call instructions that employ operands with addresses of opcode segments to call;

FIGS. 6a and 6b respectively illustrate pseudocode listings corresponding to embodiments of unconditional and conditional call instructions that support processors with N different types of cores;

FIG. 7 is a flowchart illustrating operations and logic implemented by a compiler used to compile and assemble opcode for execution on processors with heterogeneous cores, according to one embodiment;

FIG. 8a is a pseudocode listing and diagram illustrating generation of core-type specific RSA-sign functions for Big and Little core micro-architectures using a first pragma-based scheme;

FIG. 8b is a pseudocode listing and diagram illustrating generation of core-type specific RSA-sign functions for Big and Little core micro-architectures using a second pragma-based scheme;

FIG. 8c is a pseudocode listing and diagram illustrating generation of core-type specific RSA-sign functions for Big and Little core micro-architectures using a third pragma-based scheme;

FIG. 8d is a pseudocode listing and diagram illustrating generation of core-type specific RSA-sign functions for Big and Little core micro-architectures using a fourth pragma-based scheme that employs separate source code for each RSA-sign function; and

FIG. 8e is a pseudocode listing and diagram illustrating generation of core-type specific in-line branched code segments for Big and Little core micro-architectures using a firth pragma-based scheme; and

FIG. 9 is a schematic block diagram illustrating an example of an Arm-based microarchitecture;

### DETAILED DESCRIPTION

Embodiments of instruction set architectures for fine-grained heterogeneous processing and associated processors, methods, and compilers are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

ARM has implemented heterogeneous computing solutions in the client/mobile processor space with their “big.little” approach. The basic idea is that there are two designs/implementations of a specific ARM instruction-set/architecture. One of these is heavily optimized for power/energy/area, hence called “Little”. The other is a very aggressive design maximizing absolute performance, generally via super-scalar execution ports, out-of-order processing, expensive branch-prediction units, larger caches, heavy speculation/memory-prefetching etc. This is called “Big.” In the client/mobile context, it becomes possible to separate applications/tasks at launch into a critical one or a background task and tie them to big or little cores, respectively.

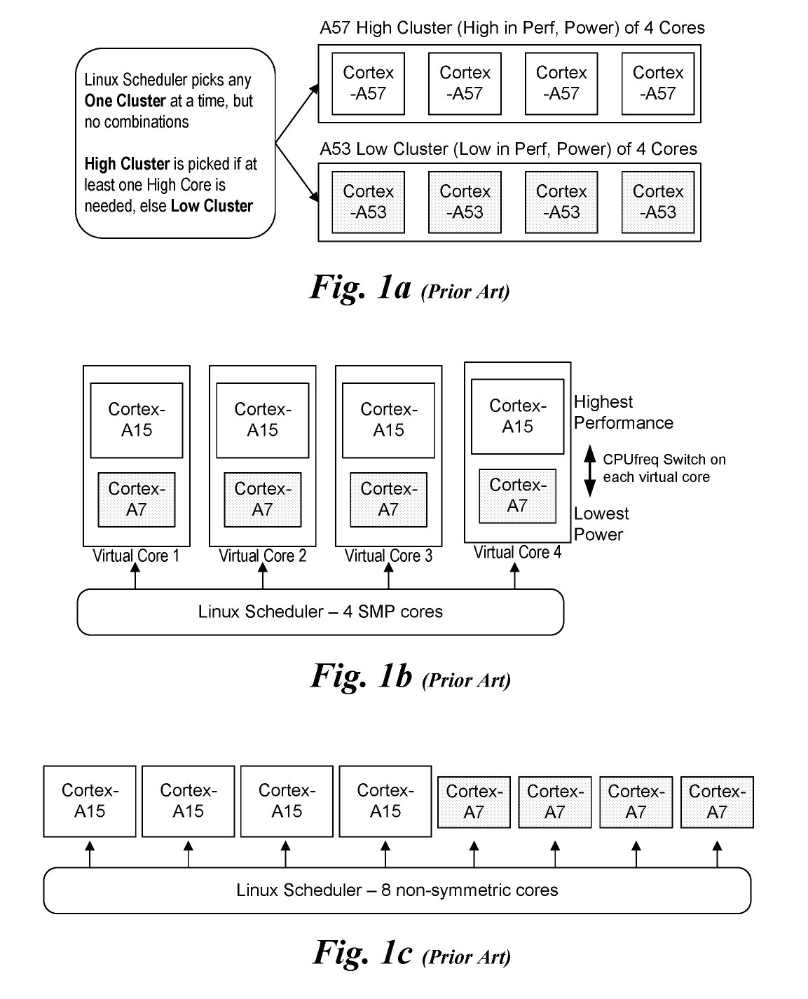

According to the Wikipedia article, there are three ways to arrange the cores depending on the scheduling of the operating system. Under a clustered switching scheme shown in FIG. 1a, the processor is configured with identically-sized clusters of “Big” (Cortex-A57) and “Little” (Cortex-A53) cores. The Linux operating system scheduler can only see one cluster at a time; when the load on the whole processor changes between low and high, the system transitions to the other cluster. All relevant data is then passed through a common L2 (Level 2) cache (not shown), the first core cluster is powered off and the other one is activated. As depicted, the High Cluster is picked if at least one High Core (i.e., Big core) is needed.

Under an in-kernel switcher scheme shown in FIG. 1b, “Big” (Cortex-A15) cores are paired with “Little” (Cortex-A7) cores, with each pair implemented as a virtual core. During operation of each virtual core only one real core (“Big” or “Little”) is powered at a time. For a given virtual core, the “Big” core is used when the demand is high, while the “Little” core is used when demand is low. When demand on the virtual core changes (between high and low), the incoming core is powered up, the running state is transferred between the cores, the outgoing core is shut down, and processing continues on the new core. Switching is done via the Linux cpufreq framework.

Under a heterogeneous multi-processing (global task scheduling) scheme shown in FIG. 1c, concurrent use of all cores is enabled. Threads with high priority or computational intensity may be allocated to the “Big” (Cortex-A15) cores while threads with less priority or less computational intensity, such as background tasks, can be executed on the “Little” (Cortex-A7) cores.

Under the ARM architectures shown in FIGS. 1a-1c, if one needs finer grained dynamic mapping of threads to cores, either the OS needs to be involved for better management of the cores, or it is possible for the hardware to move threads across the big/little cores based on voltage/frequency management schemes. Notably, each of these mechanisms is limited.

In accordance with embodiments disclosed herein, this problem is addressed by adding new instructions to the processor instruction set architecture (ISA) that dynamically enable the best function to call depending on the type of core that the thread is executing on. For example, suppose a compute-heavy function such as RSA-sign is to be executed. We could create the best-optimized code sequence or function for the different heterogeneous core micro-architectures (e.g. depending on the implementation of the multiplier, the add-with-carry instructions, load latencies and pipeline parallelism). Code including highly-tuned algorithms/implementations for a particular micro-architecture can result in approximately 2× speedups over “good” code that is optimized and works across a range of micro-architectures.

In the current processor architectures, such as the ARM architectures depicted in Figures la-c, there is no support for dynamically switching between the code sequences, and so what is generally done is to bind the right function during the application initialization or library loading time, based on the target micro-architecture. This works well with the assumption that the thread won't migrate to another micro-architecture over its lifetime; however that is not adequate under the scenario of dynamic thread migration over heterogeneous cores.

To address this deficiency, mechanisms are provided to enable respective code segments to be compiled/assembled for a target processor (or processor family) employing an ISA with the new instructions, and have the appropriate core-type code dynamically called at run-time for execution on the core the application code is currently being executed on. For example, the following call/branch instruction and function pseudocode defines two code segments rsa-sign.big and rsa-sign.little to be executed on a Big core and a Little core, respectively.

call rsa-sign.big, rsa-sign.little // A call/branch
// instruction with 2 target addresses
. . .
rsa-sign.big{ // code to run on Big core
. . . // RSA function code for Big core
}
rsa-sign.little{ // code to run on Little core
. . . // RSA function code for little core
}

During run-time execution, compiled code associated with the call will automatically be routed by the processor hardware to the compiled code segment for the rsa-sign function that matches the micro-architecture of the core the code is currently executing on. Thus every time the calling code executes, if the thread has migrated from Big-to-Little or vice versa, the code that has been compiled/assembled for the core micro-architecture on which the code is being run at this time will be selected for execution.

This approach results in substantially no added overhead (on the order of a few additional machine instructions per branch or function call); thus, it is suitable for very small functions as well as larger functions. This provides significant advantages, since many applications, such as networking applications, deal with processing packets with cycle budgets much smaller than 500 cycles; having expensive traps/system-calls and/or OS-based handling for dynamic selection of best-code would add more overhead than the performance gains achievable.

Exemplary ISA Instructions

Using the ARM-style definitions, the following four instructions are defined.

B2 label1, label2
B2 {<condition>} label1, label2
B2L sub_routine_label1, sub_routine_label2
B2L {<condition>} sub_routine_label1, sub_routine_label2

The first pair of ‘B2’ instructions are regular branch/jump instructions, whereas the second pair of ‘B2L’ instructions are “call” instructions. In each pair of the ‘B2’ branch instruction and ‘B2L’ call instruction, the first instruction is an unconditional version of the instruction and the second instruction is a conditional version of the instruction.

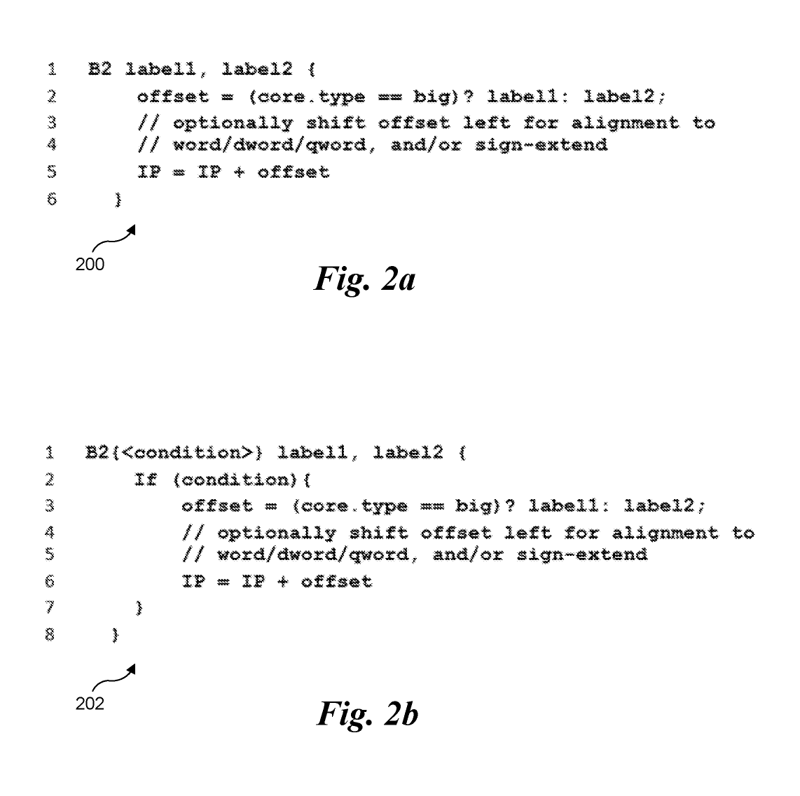

Pseudocode illustrating embodiments of an unconditional ‘B2’ branch instruction 200 and a condition ‘B2’ branch instruction 202 are shown in FIGS. 2a and 2b, respectively. As shown in line 1 of FIG. 2a, the unconditional ‘B2’ branch instruction includes a pair of operands “label1” and “label2” in which IP offset values are stored. As shown in line 2, the IP is offset (line 5) by the value define by label1 if the current core type is a big core, otherwise it is offset by the value defined by label2. As an option, the offset is shifted left so it is aligned with a word, dword, qword, and/or sign extend; use of this optional alignment mechanism will generally depend on the particular micro-architecture used for the core.

As shown in line 1 of FIG. 2b, the conditional ‘B2’ branch instruction 202 further includes condition data in addition to operands label1 and label2. If the condition defined by the condition data is met (line 2), in line 3 the instruction pointer offset to be used in line 6 is determined by the value define by label1 if the current core type is a ‘big’ core, otherwise it is offset by the value defined by label2. As before, the offset may be shifted so it is aligned with a word, dword, qword, and/or sign extend, if applicable. If the condition is not met, the instruction returns without offsetting the IP.

As a non-limiting example of condition data, the condition data might identify a register value or flag to compare to or check. If the value in the register matches the condition data or the state of a flag identified by the condition data matches a current state of the flag, the condition check if passed and the instruction thread is allowed to proceed. Otherwise, the instruction will return if the condition is not met.

Expanding on the basic definition provided above, call-type instructions are provided that call a code segment comprising a subroutine or function by both jumping/branching execution to the subroutine/function code segment appropriate for the core-type currently executing the instruction thread and storing a return address to which the core's instruction pointer is redirected after execution of the subroutine/function code segment has been completed.

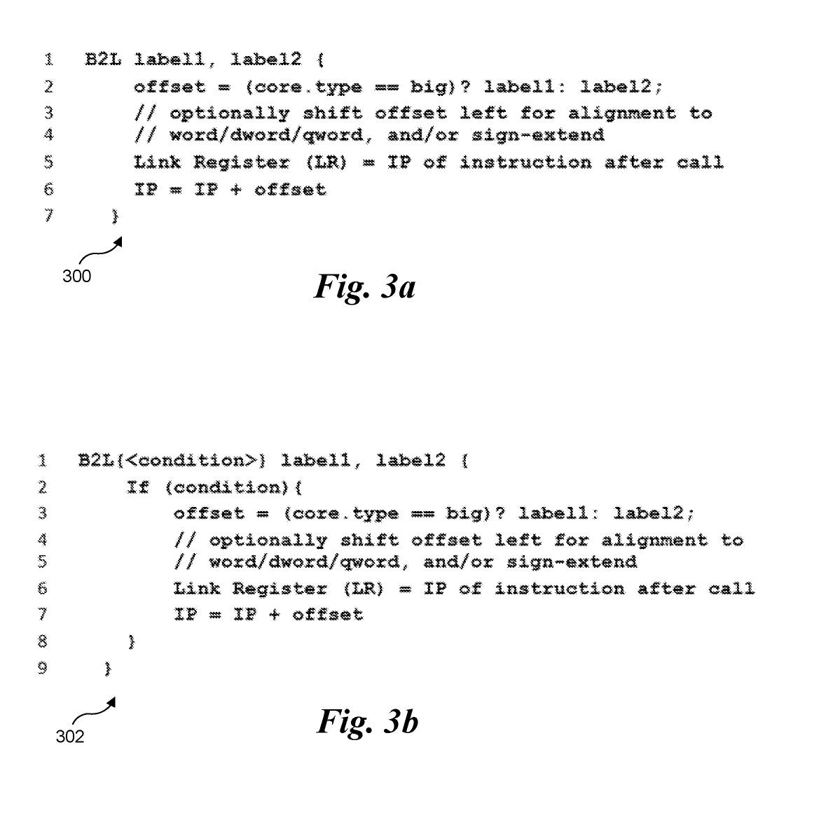

For example, under the pseudocode listings for an unconditional B2L call instruction 300 and a conditional B2L call instruction 302 respectively shown in FIGS. 3a and 3b, a Link Register (LR) is used to redirect the instruction pointer after the call. As with the unconditional and conditional B2 branch instructions 200 and 202 of FIGS. 2a and 2b, each of the unconditional B2L call instruction 300 and the conditional B2L call instruction 302 include a pair of operands “label1” and “label2,” which are used in a similar manner to operands “label1” and “label2” in the unconditional and conditional B2 branch instructions. However, the B2L call instructions further employ the LR to store the location of the instruction to be executed after the “called” code segment is executed. Under a common instruction thread execution scheme, instruction thread code segments will be stored in a sequence of address locations, such as n, n+1, n+2, n+3, etc. Accordingly the instruction pointer will jump or be branched from a current instruction address in the instruction thread being executed on the core to the first instruction in the called code segment identified by label1 or label2 (as appropriate for the core-type of the core executing the instruction thread), and return to the instruction immediately following the instruction from which the code segment was called when the called code segment is completed.

For example, suppose that that instruction at address n+2 is an unconditional 2BL instruction 300 such as shown in FIG. 3a and is executing on a ‘Big’ core. Execution of the unconditional 2BL call instruction 300 will cause the IP value to be offset by label1, resulting in an IP value of n+2+label1 being loaded into the IP register. Execution of the unconditional 2BL call instruction 300 will also load the address of the next instruction in the original thread, n+3, into LR. The next instruction to be executed will be the instruction pointed to by the IP, which will correspond to the first instruction in the “called” subroutine or function located at address n+2+label1. The code segment corresponding to the called subroutine or function will execute, and upon completion, the address in LR, n+3, will be loaded into the IP register.

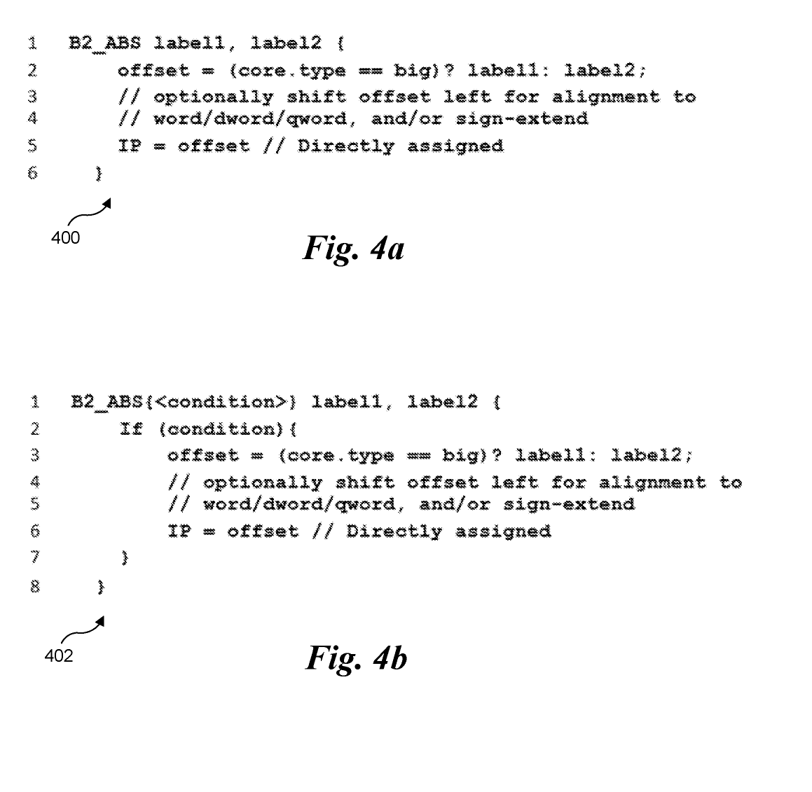

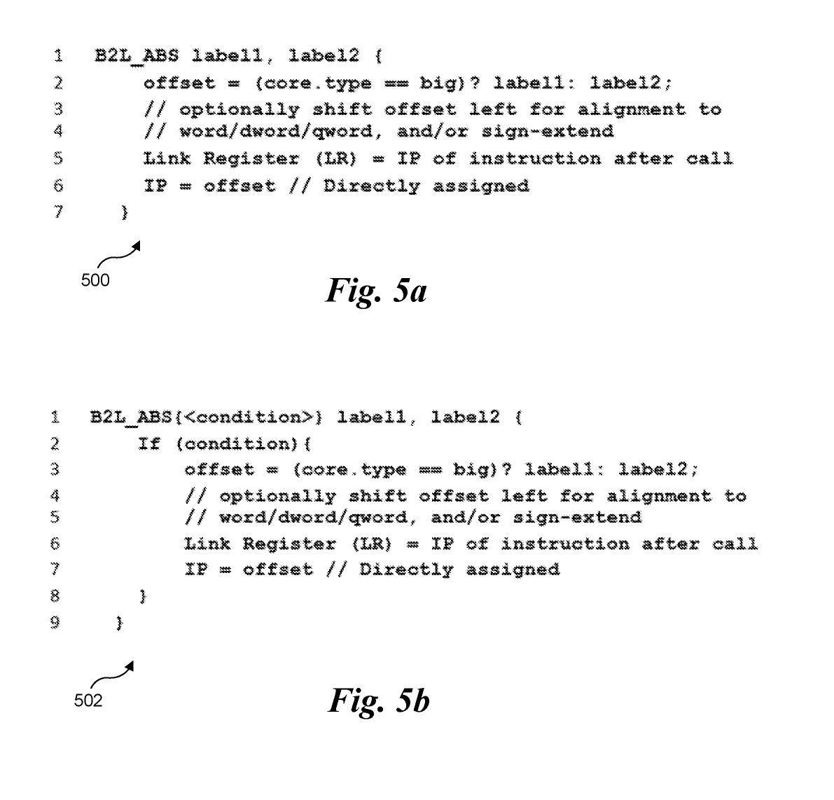

A variation of the foregoing instructions is possible (and meaningful in some processor architectures), where the label is an absolute address (e.g., as an offset into a code-segment) rather than an offset with respect to the current instruction pointer. A branch instruction example of this variant is illustrated in FIG. 4a, which depicts pseudocode corresponding to an unconditional B2_ABS branch instruction 400. Under the illustrated embodiment, the operands label1 and label2 (line 1) directly define the address to which the IP is to be set (Line 6). A similar conditional B2_ABS branch instruction 602 is shown in FIG. 4b. In addition, FIGS. 5a and 5b respectively show pseudocode for an unconditional B2L_ABS call instruction 500 and a conditional B2L_ABS call instruction 502. It is noted many variations are possible based on whether the offset is an 8-bit, 16-bit or 32-bit quantity, as well as whether it is specified via an immediate value, register operand or memory operand (depending on the CPU Architecture).

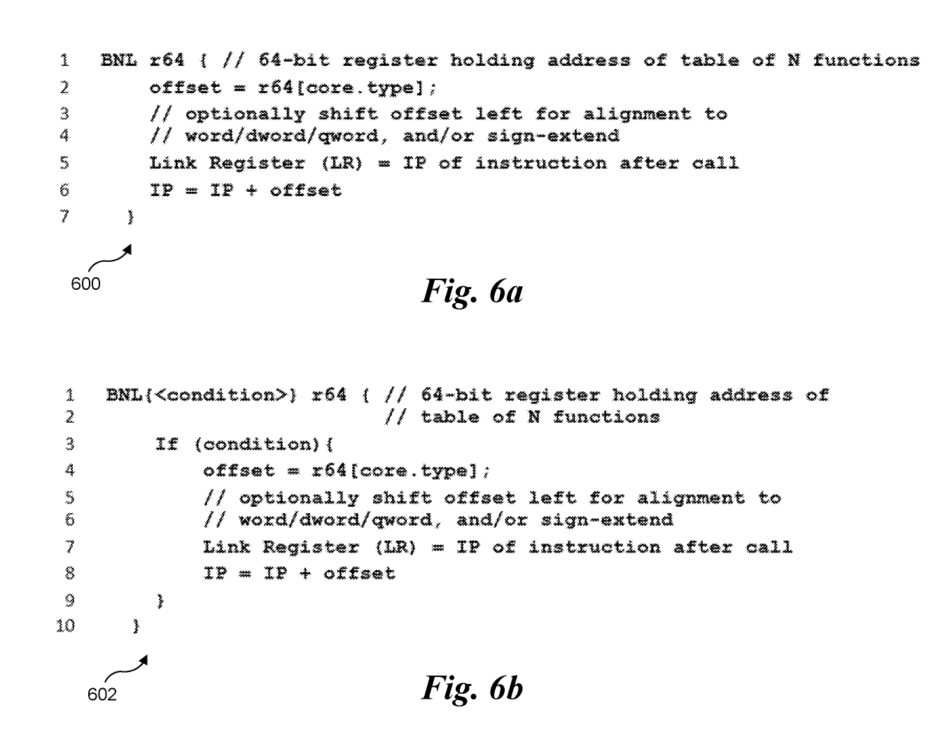

Expanding on the instructions presented above, instructions are provided that accept a list of target addresses and can branch to any one of them. While the main concept is for a call or unconditional jump/branch, extensions are provided to conditional branches as well, for completeness. For example, this concept may be extended to an N-way call, assuming there are N or more different types of cores and associated micro-architectures in the multi-core CPU. In one embodiment of an unconditional BNL call instruction 600 illustrated in FIG. 6a, the list of addresses for the N micro-architecture specific functions are stored in a table, whose address is provided in a 64-bit register operand r64. As shown in a line 2, the IP offset in the table is identified by a value in the table corresponding to the type of core in current use (core.type). In line 6, the IP is then offset by the offset determined in line 2 using the core.type as a lookup parameter for the table. Since this is a call variant, the IP of the instruction to execute after the code segment comprising the called subroutine or function is loaded into LR. A conditional version of this N-way call instruction is shown as a conditional BNL instruction 602 in FIG. 6b.

As will be recognized by those skilled in the art, the BNL instructions shown in FIGS. 6a and 6b are exemplary, and may be modified in a similar manner to some of the instructions discussed above. For example, rather than an IP offset, the table can hold addresses that are input to the core's instruction pointer. Also, in addition to call instructions, branch/jump versions of the BNL instruction may be implemented.

Intelligent Compiler Supporting Multiple Micro-Architectures.

In accordance with further aspects of this disclosure, an intelligent compiler that supports multiple micro-architectures is provided. In one aspect, the intelligent compiler generates, for marked code blocks and/or recognized functions, object code (aka “opcode”) for each of the micro-architectures supported by the core-types of the target processor the object code is generated for. For example, for a Big-core, Little-core processor, the intelligent compiler will generate separate object code segments for each of the Big-core micro-architecture and the Little-core micro-architecture. For a processor with N types of cores, N separate object code segments would be generated.

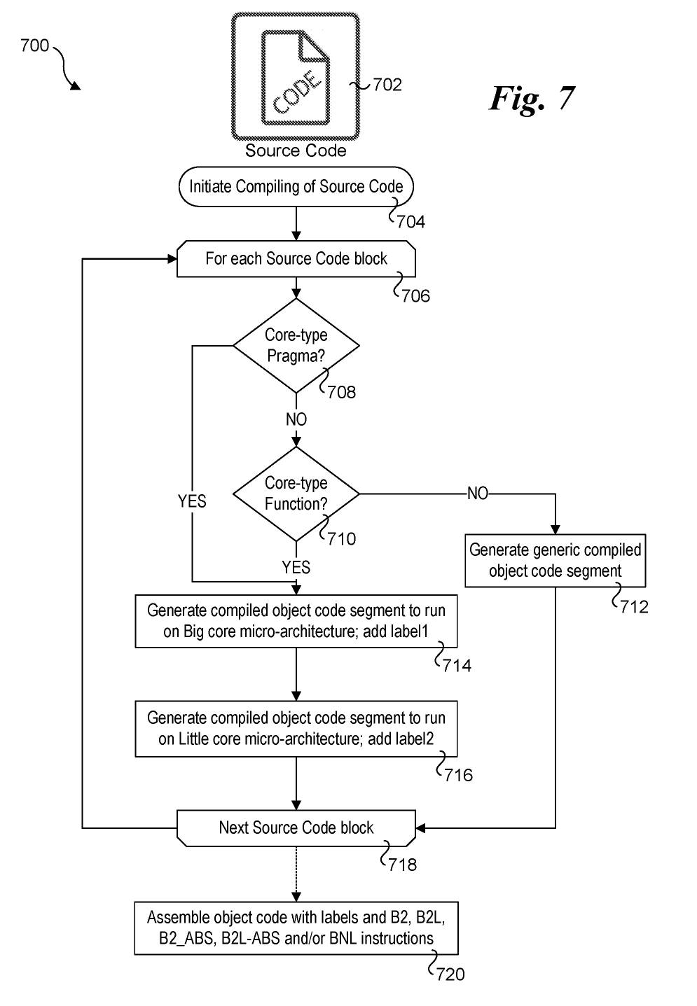

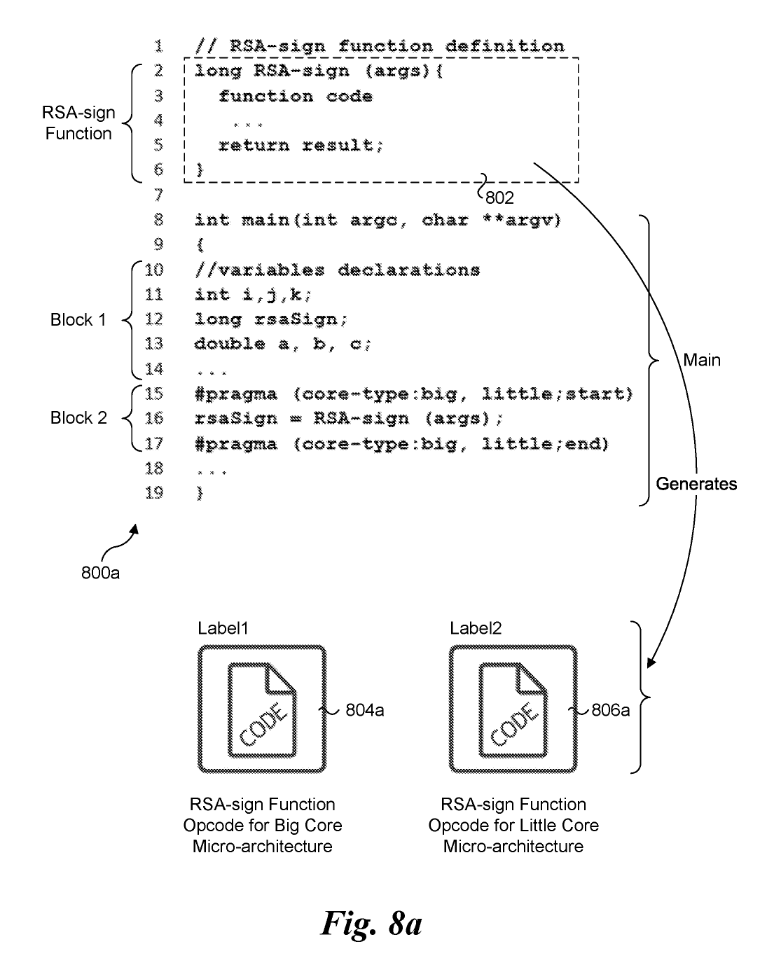

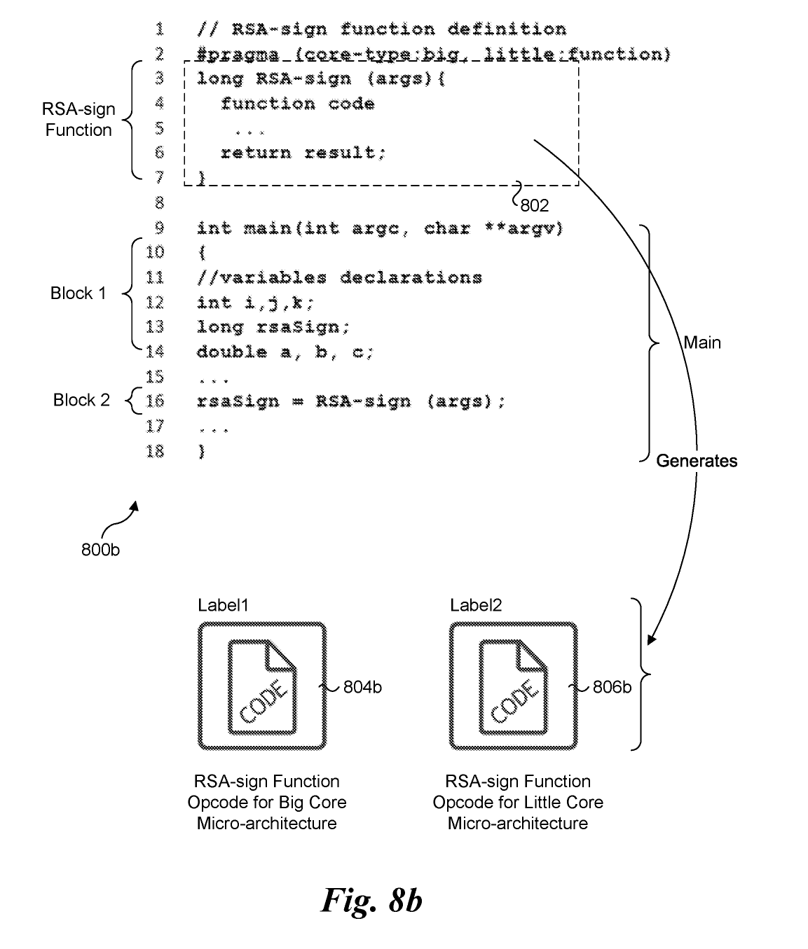

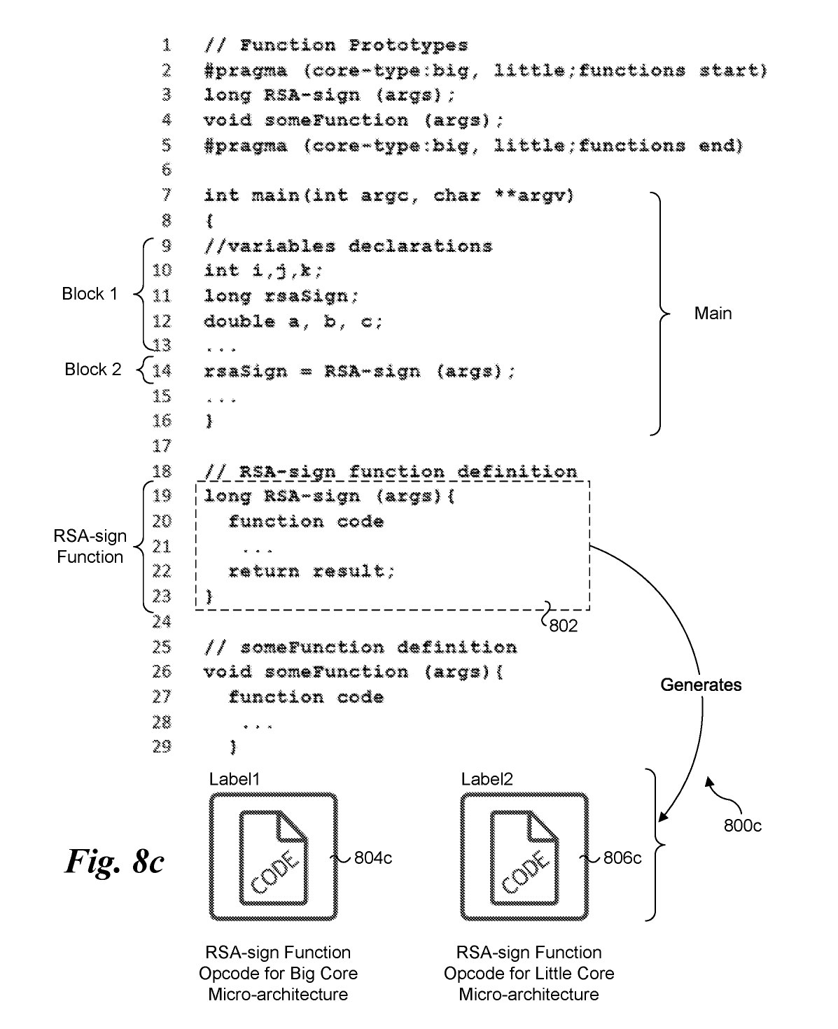

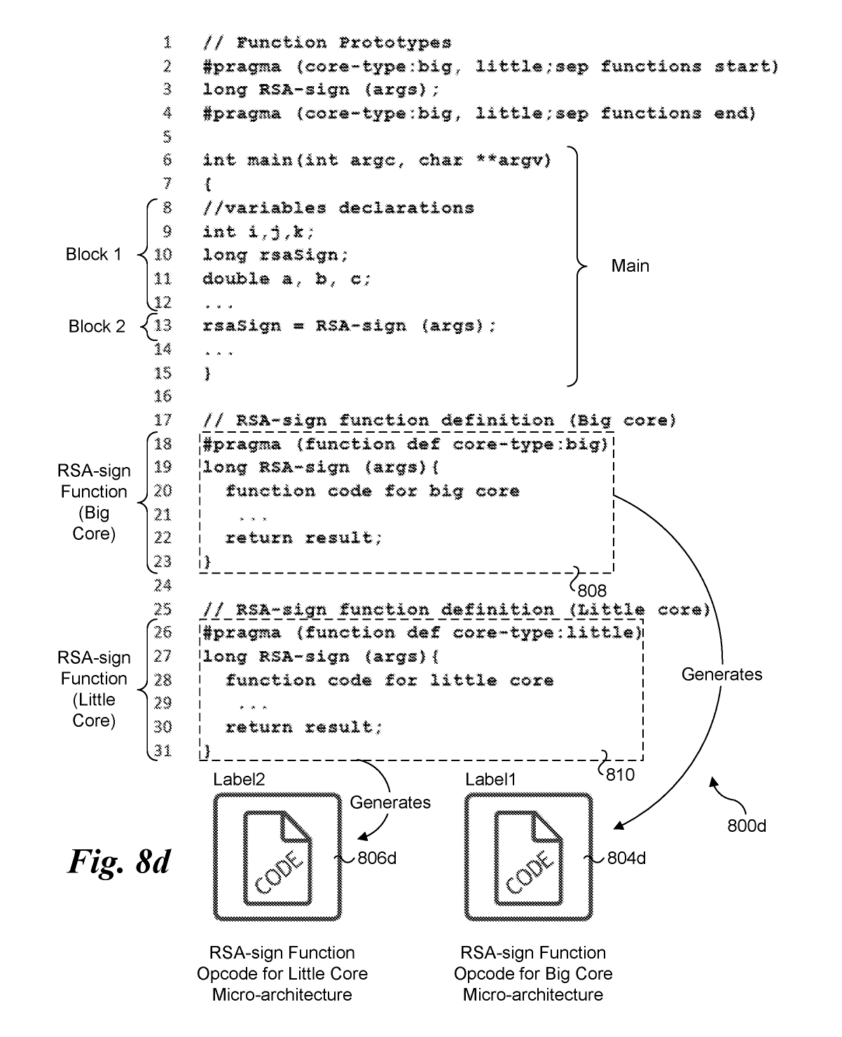

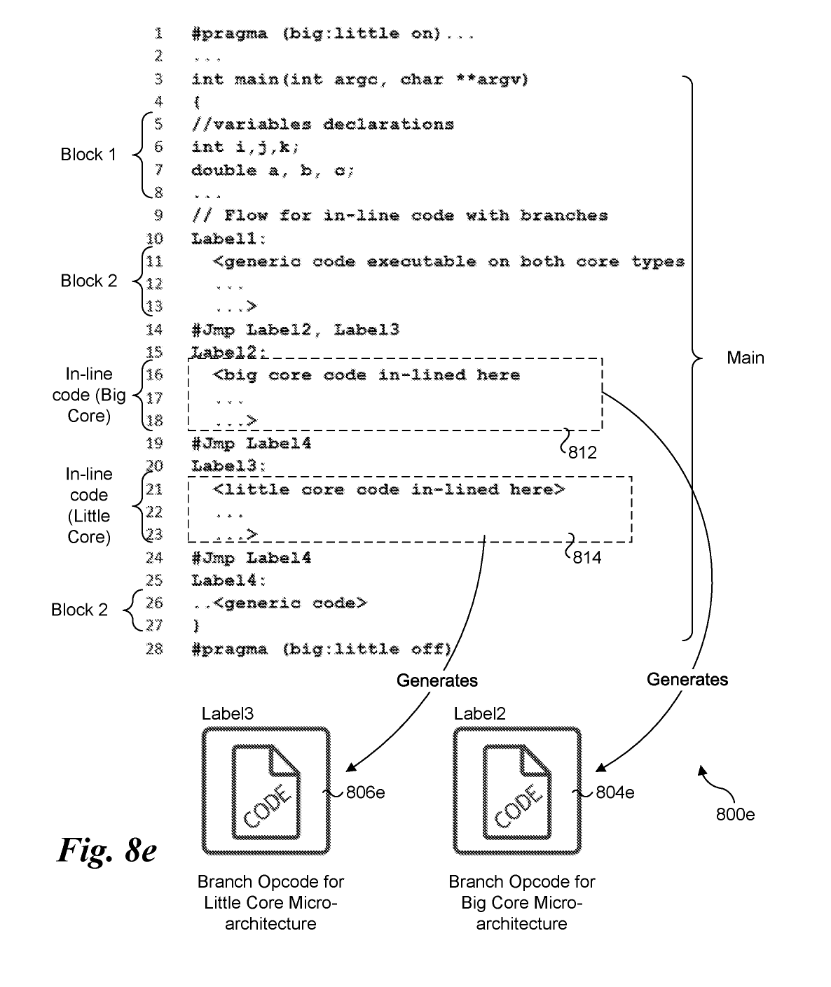

One embodiment of this approach is further illustrated by operations and logic in a flowchart 700 in FIG. 7 in view of FIGS. 8a-8d. In a start block 704, compiling of source code 702 is initiated. Generally, source code 702 may comprise source code written in various languages, and may be a procedural language (such as C) or an object-oriented language (such as C++). The pseudocode listing 800a example illustrated in FIG. 8a employs a procedural language, and thus the operations and logic of flowchart 700 will be described in the context of a procedural language. However, this is not limiting, as similar techniques may be used for object-oriented languages.

Pseudocode listing 800a shows an abstracted representation of a portion program source code including an RSA-sign function definition in lines 2-6 and a main function in lines 8-19. The main function also includes two program blocks labeled Block 1 and Block 2. The program structure corresponds to a procedural language such as C, where functions are called from within a code section, but are defined external to the code section. While it is also possible to define so-called “in-line” functions in C, this is less common than externally-defined (to the C main function) functions.

Returning to flowchart 700 of FIG. 7, as depicted by start and end loop blocks 706 and 718, the operations and logic within this loop (decision blocks 708 and 710 and blocks 712, 714, and 716) are perform for each block of source code. Generally, in this example, code blocks will comprise groupings of one or more instructions that are either non-specific to a particular function or part of a particular function. In some embodiments, code blocks will be divided using pragma statements, as describe in further detail below. An example of demarcation of code blocks using pragma statements is illustrating in pseudocode listing 800a.

Generally, in languages such as C and C++, pragma statements are used to provide directives to a compiler beyond what is conveyed by the source code itself. Under one embodiment, pragmas as used to delineate code blocks that are to be compiled for more than one micro-architecture. For example, as shown in pseudocode listing 800a, a #pragma (core-type:big, little; start) statement in line 15 is used to tell the compiler that the following block of code is to be separately compiled for each of the micro-architecture used for the big core-type and the micro-architecture used for the little core type. A second program statement #pragma (core-type:big, little;end) in line 17 is used to mark the end of the code block that is to be compiled for both micro-architectures. As will be recognized by those skilled in the art, these pragma statements are merely exemplary and various usages of pragma statements may be used. For example, in one embodiment the compiler is configured for a Big-core, Little-core compilation scheme, and code blocks to be compiled for both micro-architectures simply use #pragma on and #pragma off statements or something similar. A similar approach may be used to support a processor having N core-types by informing the compiler that it is to generate opcode for a heterogeneous processor with N core-types.

In one embodiment, function definitions themselves may be marked as core-type functions. For example, the function definition could include a separate type of pragma to mark the function as a core-type function, or a core-type function may be defined in a library of core-type functions. As used herein, a core-type function means a function that is to be compiled to produce opcode that is designed to run on core-types with specific micro-architectures. Generally, the pragma directive can define the code is to be compiled for a single micro-architecture or multiple micro-architectures. This approach may be used for both procedural languages and object-oriented languages.

Example core-type function pragma schemes are shown in pseudocode listings 800b and 800c of FIGS. 8b and 8c. In pseudocode listing 800b, a #pragma (core-type:big, little;function) is added in line 2 prior to the RSA-sign function definition in lines 3-7. In this embodiment, the use of “function” in the pragma tells the compiler this pragma only applies to the following function, and thus an end pragma is not needed. Under the approach in pseudocode listing 800c of FIG. 8c, a pragma block (lines 2-5) is defined in a function prototype section at the top of the listing. What these pragma statements tells the compiler is the functions within the pragma block are to be compiled for both big and little core architectures.

The foregoing approach may also be implemented via object-oriented programming languages. In one embodiment, pragmas may be included in a class header and/or class definition file, depending on the implementation.

Returning to flowchart 700 and pseudocode listing 800a, presume the compiler has reached the main function, which begins at line 8. The main function is not marked with a pragma and is not a core-type function. The first code block in main that is evaluated is Block 1, which corresponds to the block of code in main before the pragma statement in line 15. In the present example, this code block is a set of variable definitions that are handled the same way in both micro-architectures for the Big and Little cores. Thus, this code block can be compiled using “generic” object code that is the same for both micro-architectures. During the pass through flowchart 700's loop for Block 1, the answer to each of decision blocks 708 and 710 is NO, resulting in the logic proceeding to block 712 in which generic object code for the code block is generated by the compiler. The logic then proceeds to end loop block 718 and loops back to start loop block 706 to begin processing the next code block (Block 2).

Block 2 contains core-type pragma statements in lines 15 and 17. Accordingly, the answer to decision block 708 is YES, and the logic proceeds to block 714 in which an object code segment configured to run on the Big core micro-architecture is compiled, and a label is added (label1). The portion of source code that will be compiled is the source code between the pragma start and end statements, which in this case is a call to the RSA-sign function. The compiler will recognize the RSA-sign function is defined elsewhere, which in this example is in lines 2-6 prior to the main function. Optionally, the definition of the function could be defined in another file that the compiler would be aware of based on information contained in a header file that is imported via an import statement (not shown). As illustrated at the bottom of FIG. 8a, RSA-sign function opcode segment 804a configured to be executed on the Big core micro-architecture is generated.

Next, the logic proceeds to block 716, wherein similar operations are performed to generate opcode segment 806a configured to be execute on the Little core micro-architecture. A label (label2) is also added. The logic then proceeds to end loop block 718, which determines Block 2 is the last source code block, resulting in the logic proceeding to a block 720.

In block 720 the object code is assembled and one or more B2, B2L, B2_ABS, B2L_ABS and BNL instructions with applicable labels are added in appropriate locations in the assembled code such that when the code is executed on a processor with multiple core-types having different micro-architectures, the opcode segment for the micro-architecture corresponding to the type of core the instruction thread is being executed on is branched to or called (depending on whether the instruction is a branch-type or call-type instruction). Generally, the compiler will assemble code from one or more modules, and the operations depicted in block 720 may be implemented during an assembly phase by the compiler or otherwise as part of the compilation process.

Source code corresponding to the pseudocode listings 800b and 800c is processed in a similar manner, albeit in a different order than that described above for pseudocode listing 800a. For example, in pseudocode listing 800b, the RSA function in lines 3-7 follows a pragma statement instructing the compiler to compile separate opcode segments 804b and 806b for the RSA-sign function for each of the Big and Little core micro-architectures. When the compiler processes lines 2-7, the separate opcode segments are generated (or otherwise marked internally for subsequent generation). When the compiler reaches the call to the RSA-sign in line 16, the call is marked internally such that when the corresponding opcode is assembled, one of a B2, B2L, B2_ABS, or B2L_ABS instruction is generated that includes the appropriate labels that identify the locations of the assembled code for executing the RSA-sign function on each of the Big and Little cores.

As described above, pseudocode listing 800c illustrates an example of using a pragma block including one or more function prototypes. Under this coding scheme, the pragma statements in lines 2 and 5 instruct the compiler to generate opcode for both the Big and Little core micro-architectures for each function in the block, which includes both the RSA-sign function in line 3 and a second function (called someFunction) in line 4. When the compiler processes Block 2, it recognizes that the statement in line 14 calls the RSA-sign function that corresponds to a core-type function, which results in a YES answer to decision block 710 in flowchart 700. Accordingly, when the compiler processes the code defining the RSA-sign function in lines 19-23, opcode segments 804c and 806c for the respective Big and Little core micro-architectures are generated. When the opcode segments are assembled in block 720, an applicable B2, B2L, B2_ABS, or B2L_ABS instruction is added to effect calling the RSA-sign function in line 14, along with appropriate labels that are used to locate the respective opcode segments for execution on the Big and Little core micro-architectures.

In addition to having the compiler generate opcode segments for separate micro-architectures from the same source code-level function definition, support for defining different source code-level function definitions may also be provided. For example, the micro-architecture for one type of core may have support for built-in functions that are not available via the micro-architecture for the other type(s) of cores on the processor. There may be instances in which accessing such functions involves use of corresponding instructions at the source code level. Thus, the source code definition for the functions themselves will differ. At the same time, a single form of the function is used at the source code level to call the function or branch to an opcode segment targeted for execution on a particular type of processor core and micro-architecture.

An example of this is illustrated in pseudocode listing 800d of FIG. 8d. In lines 2 and 4 a pragma block is defined that informs the compiler that there are separate function definitions in the source code for the RSA-sign function. A code block 808 comprising a representation of the RSA-sign function definition for the Big core is shown in lines 18-23, while a code block 810 comprising a representation of the RSA-sign function definition for the Little core is shown in 26-31. Line 18 includes a pragma statement that instructs the compiler that the following function is a function definition for the Big core, which, when processed by the compiler generates opcode segment 804d. Similarly, line 26 includes a pragma statement that instructs the compiler that the following function is a function definition for the Little core, which, when processed by the compiler generates opcode segment 806d. Subsequently, the opcode segments are assembled, with appropriate B2, B2L, B2_ABS, or B2L_ABS instructions and labels being added in a similar manner to that described above.

It is noted that in the example code in pseudocode listing 800d, the function name and the list of arguments (args) for both versions of the RSA-sign functions are the same. This enables any call to the function to have the same format. While this would normally be illegal (you can't normally redefine the same function with identical arguments), the use of the pragma statements in lines 18 and 26 identifies these as separate functions, thus overriding detection of a redefinition of the RSA-sign function in line 27.

Branch Instruction Example

A pseudocode listing 800e illustrating generation of core-type specific branched opcode segments is shown in FIG. 8e. In line 1, a pragma is used to tell the compiler to start compiling for Big and Little cores. Branch instructions are used to branch the instruction thread in-line, where the instruction thread is first “jumped” to a first label at the start of a code block and then jumped to a second label following completion of the code block. It is somewhat similar to a call, but rather than returning the instruction thread back to where the function was called, a branch instruction continues at some other point in the assembled code.

The main function spans lines 3-27. Block 1 is processed in a similar manner to that discussed above, with generic opcode generated for the variable declarations. Next, in line 10, a label (Label1) is encountered by the compiler. Labels are commonly used in source code for branching and other purposes. In this example, Label1 is recognized as a label for a generic code segment, and thus the opcode generated from Block 2 is also generic code.

In line 14, the compiler encounters a pragma statement #Jmp Label2, Label3. This tells the compiler to generate respective opcode segments for the Big and Little cores, with the code to compile for the respective core-types being delineated by labels Label2 (line 16) and Label3 (line 20). As illustrated, the compiler generates branch opcode segment 804e targeted for execution on the Big core micro-architecture when it processes a code block 812 corresponding to an in-line Big core code segment in lines 16-18. The compiler also stores label data linking Label2 to branch opcode segment 804e. The pragma #Jmp Label4 instructs the compiler to generate a jump instruction to a code address corresponding to Label4 (the address will be dynamically generated by the compiler).

Similarly, when processing lines 20-23, the compiler will generate branch opcode segment 806e targeted for execution on the Little core micro-architecture when it processes code block 814 corresponding to an in-line Little core code segment in lines 21-23, and store data linking Label3 to branch opcode segment 806e. As before, the pragma #Jmp Label4 instructs the compiler to generate a jump instruction to a code address corresponding to Label4. The remaining code in lines 26 following Label4 in line 25 is then generated as generic opcode. Finally, the pragma statement in line 28 turns the Big:Little compiler directive off.

When the compiler assembles the opcode segments, it generates appropriate B2, B2L, B2_ABS, or B2L_ABS instructions and adds the labels as indicated. For example, to selective execute opcode segments 804e and 806e, the compiler will generate an unconditional instruction such as B2 Label2, Label3 or B2_ABS Label2, Label3.

In addition to the exemplary pragmas shown, other types of pragmas may be used that contain hints to instruct the compiler what type of B2, B2L, B2_ABS, B2L_ABS and BNL instructions to use. As yet another option, an integrated development environment (IDE) may be used for both editing and compiling the source code. The IDE may include function libraries and/or application program interfaces (APIs) with pre-built functions that are pre-compiled to support multiple micro-architectures. Accordingly, the source code may include calls to the pre-built functions rather than using pragmas. Access to such libraries and/or APIs may be provided through conventional means, such as #include library_name or include <library_name> statements in the source code in a manner commonly used in many programming languages.

Figure

Example Arm Big Processor Core Micro-Architecture

Generally, the B2, B2L, B2_ABS, B2L_ABS and BNL instructions may be implemented in processors employing cores having various micro-architectures. However, this is merely exemplary and non-limiting, as variants of the foregoing instructions may be implemented on various processor architectures. For example, consider the RISC-style Arm processor. The instructions are generally capable of 3 operands. They have integer scalar instructions that work on general-purpose registers (GPRs) (e.g., 16 or 32 registers), and vector/floating-point instructions that work on 128-bit SIMD (called Neon) registers.

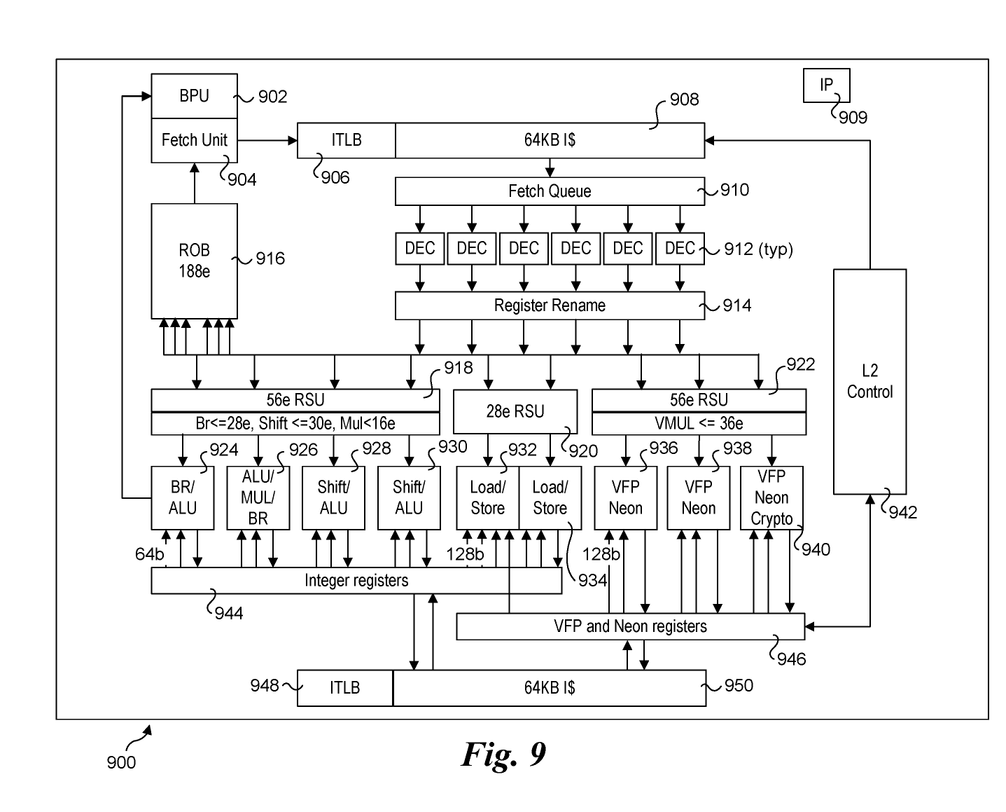

An example of one embodiment of an Arm processor micro-architecture 900 that may be implemented in Big cores in a processor having heterogeneous Big and Little cores, is shown in FIG. 9. Micro-architecture 900 includes a branch prediction unit (BPU) 902, a fetch unit 904, an instruction translation look-aside buffer (ITLB) 906, a 64KB (Kilobyte) instruction store 908, an instruction pointer 909, a fetch queue 910, a plurality of decoders (DECs) 912, a register rename block 914, a reorder buffer (ROB) 916, reservation station units (RSUs) 918, 920, and 922, a branch arithmetic logic unit (BR/ALU) 924, an ALU/MUL(Multiplier)/BR 926, shift/ALUs 928 and 930, and load/store blocks 932 and 934. Micro-architecture 900 further includes vector/floating-point (VFP) Neon blocks 936 and 938, and VFP Neon cryptographic block 940, an L2 control block 942, integer registers 944, 128-bit VFP and Neon registers 946, an ITLB 948, and a 64 KB instruction store 950.

Generally, in a Big-core, Little-core processor architecture, the Little core micro-architecture will be simpler than the Big core micro-architecture. Due to the differences in the micro-architectures the opcode instructions available to each architecture may differ, and as a result, the opcode generated for the same source code may also differ, as discussed above. At the same time, each micro-architecture in a heterogeneous processor will generally support similar set of fundamental operations, thus enabling generic opcode to be run on both micro-architectures.

The principles and techniques described herein are not limited to Arm-based processors, but rather the discussion and illustrations of Arm-based heterogeneous processors herein are merely exemplary and non-limiting. For example, similar principles and techniques may be applied to CISC-type processors, such as processors employing x86-based micro-architectures.

Further aspects of the subject matter described herein are set out in the following numbered clauses:

1. A processor comprising:

a plurality of processor cores, each having an instruction pointer (IP), the plurality of processor cores including at least one first type of processor core implementing a first micro-architecture and at least one second type of processor core implementing a second micro-architecture;

an instruction set architecture (ISA) including an instruction having first and second operands respectively used to store data from which a first location of a first code segment configured to be executed on the first type of processor core can be determined and a second location of a second code segment configured to be executed on the second type of processor core can be determined, wherein execution of the instruction on one of the plurality of processor cores causes the processor to,

update the IP of the processor core to point to the first or second location based on the type of core that is executing the instruction.

2. The processor of clause 1, wherein the processor cores include at least one big core and at least one little core, wherein each of the at least one big core is associated with the first micro-architecture and wherein each of the at least one little core is associated with the second micro-architecture, and wherein a little core consumes less power than a big core.

3. The processor of clause 1 or 2, wherein the first and second micro-architectures are ARM-based micro-architectures.

4. The processor of any of the preceding clauses, wherein the first and second operands are used to store first and second IP offsets, and wherein execution of the instruction on the processor core causes a value in the IP of the processor core to be offset by the first IP offset if the processor core corresponds to the first type of processor core or causes the value of the IP of the processor core to be offset by the second IP offset if the processor core corresponds to the second type of processor core.

5. The processor of any of the preceding clauses, wherein the first and second operands are used to store first and second addresses, and wherein execution of the instruction on the processor core causes the first address to be loaded into the IP of the processor core if the processor core is the first core type of processor core or causes the second address to be loaded into the IP of the processor core if the processor core is the second type of processor core.

6. The processor of any of the preceding clauses, wherein the instruction is a branch instruction that branches to the first code segment when the branch instruction is executed on the first type of processor core and branches to the second code segment when the branch instruction is executed on the second type of processor core.

7. The processor of clause 6, wherein the branch instruction is a conditional branch instruction that includes a third operand to store data that is evaluated by the processor core when the instruction is executed to determine whether or not to branch to either of the first and second code segments.

8. The processor of any of the preceding clauses, wherein the instruction is a call instruction that calls the first code segment when the call instruction is executed on the first type of processor core and calls the second code segment when the call instruction is executed on the second type of processor core.

9. The processor of clause 8, wherein the call instruction is a conditional call instruction that includes a third operand to store data that is evaluated by the processor core when the instruction is executed to determine whether or not to call either of the first and second code segments.

10. The processor of any of the preceding clauses, wherein the processor includes N or more different types of cores and the ISA includes an instruction that, when executed on one of the processor cores causes the processor to:

read a register containing a location of a table containing information that maps each of the N different types of cores to a location at which a code segment corresponding to that type of core is located; and

retrieve, from the table, the location of the code segment associated with the type of core the processor core executing the instruction is.

11. A method performed by a processor having a plurality of processor cores including at least one first type of processor core implementing a first micro-architecture and at least one second type of processor core implementing a second micro-architecture, the method comprising;

executing an instruction on a processor core to cause the processor core to execute a first code segment if the processor core is the first type of processor core or to execute a second code segment if the processor core is the second type of processor core.

12. The method of clause 11, wherein the processor cores include at least one big core and at least one little core, wherein each of the at least one big core is associated with the first micro-architecture and wherein each of the at least one little core is associated with the second micro-architecture, and wherein a little core consumes less power than a big core.

13. The method of clause 11 or 12, wherein the first and second micro-architectures are ARM-based micro-architectures.

14. The method of clause any of clauses 11-13, wherein each of the plurality of processor cores includes an instruction pointer (IP), wherein the instruction includes first and second operands used to store first and second IP offsets, and wherein execution of the instruction on the processor core causes a value in the IP of the processor core to be offset by the first IP offset if the processor core is the first type of processor core or causes the value of the IP of the processor core to be offset by the second IP offset if the processor core is the second type of processor core.

15. The method of clause any of clauses 11-14, wherein each of the plurality of processor cores includes an instruction pointer (IP), wherein the instruction includes first and second operands used to store first and second addresses, and wherein execution of the instruction on the processor core causes the first address to be loaded into the IP of the processor core if the processor core is the first core type of processor core or causes the second address to be loaded into the IP of the processor core if the processor core is the second type of processor core.

16. The method of clause any of clauses 11-15, wherein the instruction is a branch instruction that branches to the first code segment when the branch instruction is executed on the first type of processor core and branches to the second code segment when the branch instruction is executed on the second type of processor core.

17. The method of clause 16, wherein the branch instruction is a conditional branch instruction that includes a third operand to store condition data, further comprising:

evaluating the condition data to determine whether or not to branch to either of the first and second code segments.

18. The method of clause any of clauses 11-17, wherein the instruction is a call instruction that calls the first code segment when the call instruction is executed on the first type of processor core and calls the second code segment when the call instruction is executed on the second type of processor core.

19. The method of clause 18, wherein the call instruction is a conditional call instruction that includes a third operand to store conditional data, further comprising:

evaluating the condition data to determine whether or not to call either of the first and second code segments.

20. The method of clause any of clauses 11-19, wherein the processor includes N or more different types of cores, each having a respective micro-architecture, further comprising:

reading a register containing a location of a table containing information that maps each of N different types of cores to a location at which a code segment corresponding to that type of core is located;

retrieving, from the table, the location of the code segment associated with the type of core the processor core executing the instruction is; and

causing the processor core to begin executing that code segment.

21. A non-transitory machine-readable medium having instructions stored thereon comprising a compiler to generate and assembly opcode to be executed on a target processor having a plurality of processor cores including at least one first type of processor core implementing a first micro-architecture and at least one second type of processor core implementing a second micro-architecture, wherein execution on a host machine enables the compiler is enabled to:

identify a block of source code for which respective first and second opcode segments are to be generated, the first opcode segment configured to be executed one the first type of processor core using the first micro-architecture, the second opcode segment configured to executed on the second type of processor core using the second micro-architecture;

generate each of the first and second opcode segments; and

generate an instruction that is part of an instruction set architecture (ISA) for the target processor that, when executed by one of the plurality of processor cores is configured to cause an execution thread of the processor core to jump to either a first instruction in the first opcode segment if the processor core is the first type of processor core or to jump to a first instruction in the second opcode segment if the processor core is the second type of processor core.

22. The non-transitory machine-readable medium of clause 21, wherein the processor cores include at least one big core and at least one little core, wherein each of the at least one big core is associated with the first micro-architecture and wherein each of the at least one little core is associated with the second micro-architecture, and wherein a little core consumes less power than a big core.

23. The non-transitory machine-readable medium of clause 21 or 22, wherein the first and second micro-architectures are ARM-based micro-architectures.

24. The non-transitory machine-readable medium of any of clauses 21-23, wherein the instruction includes first and second operands that are used to store first and second instruction pointer (IP) offsets, and wherein the instruction is configured such that execution of the instruction on the processor core causes a value in the IP of the processor core to be offset by the first IP offset if the processor core corresponds to the first type of processor core or causes the value of the IP of the processor core to be offset by the second IP offset if the processor core corresponds to the second type of processor core.

25. The non-transitory machine-readable medium of any of clauses 21-23, wherein the instruction includes first and second operands that are used to store first and second addresses, and wherein execution of the instruction on the processor core causes the first address to be loaded into an instruction pointer (IP) of the processor core if the processor core is the first core type of processor core or causes the second address to be loaded into the IP of the processor core if the processor core is the second type of processor core.

26. The non-transitory machine-readable medium of any of clauses 21-25, wherein the instruction is a branch instruction that branches to the first code segment when the branch instruction is executed on the first type of processor core and branches to the second code segment when the branch instruction is executed on the second type of processor core.

27. The non-transitory machine-readable medium of clause 26, wherein the branch instruction is a conditional branch instruction that includes a third operand to store data that is evaluated by the processor core when the instruction is executed to determine whether or not to branch to either of the first and second code segments.

28. The non-transitory machine-readable medium of any of clauses 21-25, wherein the instruction is a call instruction that calls the first code segment when the call instruction is executed on the first type of processor core and calls the second code segment when the call instruction is executed on the second type of processor core.

29. The non-transitory machine-readable medium of clause 28, wherein the call instruction is a conditional call instruction that includes a third operand to store data that is evaluated by the processor core when the instruction is executed to determine whether or not to call either of the first and second code segments.

30. The non-transitory machine-readable medium of any of clauses 21-29, wherein the processor includes N or more different types of cores, each having a respective micro-architecture, wherein execution on the host machine further enables the compiler is enabled to:

identify a block of source code for which N different opcode segments are to be generated, each of the N different opcode segments being configured to be executed on a respective micro-architecture;

generate each of the N different opcode segments; and

generate an instruction that is part of the ISA for the target processor that, when executed by one of the plurality of processor cores is configured to cause an execution thread of the processor core to jump to a first instruction in an opcode segment that is configured to be executed by the type of core executing the instruction.

31. A processor comprising:

a plurality of processor cores, each having an instruction pointer (IP), the plurality of processor cores including N or more different types of cores, each type of core implementing a respective micro-architecture;

an instruction set architecture (ISA) including an instruction that, when executed on one of the processor cores causes the processor to:

read a register containing a location of a table containing information that maps each of N different types of cores to a location at which a code segment corresponding to that type of core is located; and

retrieve, from the table, the location of the code segment associated with the type of core the processor core executing the instruction is.

32. The processor of clause 31, wherein the location that is retrieved is an IP offset, and wherein execution of the instruction further causes the processor to offset an IP for the process core by the IP offset.

33. The processor of clause 31, wherein the location that is retrieved is an address, and wherein execution of the instruction further causes the processor to set a value in the IP for the processor core to the address.

34. The processor of any of the clauses 31-33, wherein the instruction is a branch instruction.

35. The processor of clause 34, wherein the branch instruction is a conditional branch instruction.

36. The processor of any of the clauses 31-33, wherein the instruction is a call instruction.

37. The processor of clause 36, wherein the call instruction is a conditional call instruction.

38. The processor of any of clauses 31-37, wherein each of the N types of cores implement are ARM-based micro-architectures.

39. A method performed by a processor having a plurality of processor cores, each having an instruction pointer (IP), the plurality of processor cores including N or more different types of cores, each type of core implementing a respective micro-architecture, the method comprising:

executing an N-way instruction on a first type of processor core to cause an instruction thread executing on the first type of processor core to jump to a first code segment that has been compiled for the micro-architecture implemented by the first type of processor core; and

executing the N-way instruction on a second type of processor core to cause an instruction thread executing on the second type of processor core to jump to a second code segment that has been compiled for the micro-architecture implemented by the second type of processor core.

40. The method of clause 39, further comprising:

during execution of the N-way instruction on each of the first type and second type of processor core,

determining what type of core the processor core is;

reading a register containing a location of a table containing information that maps each of N different types of cores to a location at which a code segment corresponding to that type of core is located; and

retrieving the location of the code segment associated with the type of core the processor core is determined to be from the table.

41. The method of clause 40, wherein the location that is retrieved is an IP offset, further comprising offsetting a current value in the IP for the processor core by the IP offset that is retrieved from the table.

42. The method of clause 40, wherein the location that is retrieved is an address, further comprising setting a value in the IP for the processor core to the address that is retrieved from the table.

43. The method of any of the clauses 39-42, wherein the instruction is a branch instruction.

44. The method of clause 43, wherein the branch instruction is a conditional branch instruction, further comprising:

evaluating a condition associated with the instruction; and

if the condition is true, allowing the instruction to be completed, otherwise skipping a remainder of the instruction.

45. The method of any of the clauses 39-42, wherein the instruction is a call instruction.

46. The method of clause 45, wherein the call instruction is a conditional call instruction, further comprising:

evaluating a condition associated with the instruction; and

if the condition is true, allowing the instruction to be completed, otherwise returning execution to a point in an instruction point from where the conditional call instruction was called.

47. The method of any of clauses 39-46, wherein each of the N types of cores implement are ARM-based micro-architectures.

In addition, embodiments of the present description may be implemented not only within a semiconductor chip but also within machine-readable media. For example, the designs described above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behavioral level netlist, a register transfer level (RTL) netlist, a gate level netlist and a transistor level netlist. Machine-readable media also include media having layout information such as a GDS-II file. Furthermore, netlist files or other machine-readable media for semiconductor chip design may be used in a simulation environment to perform the methods of the teachings described above.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘n’ and ‘N’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A processor comprising:
a plurality of processor cores, each having an instruction pointer (IP), the plurality of processor cores including at least one first type of processor core implementing a first micro-architecture and at least one second type of processor core implementing a second micro-architecture;
an instruction set architecture (ISA) including an instruction having first and second operands respectively used to store data from which a first location of a first code segment configured to be executed on the first type of processor core can be determined and a second location of a second code segment configured to be executed on the second type of processor core can be determined, wherein execution of the instruction on one of the plurality of processor cores causes the processor to,
update the IP of the processor core to point to the first or second location based on the type of core that is executing the instruction.

2. The processor of claim 1, wherein the processor cores include at least one big core and at least one little core, wherein each of the at least one big core is associated with the first micro-architecture and wherein each of the at least one little core is associated with the second micro-architecture, and wherein a little core consumes less power than a big core.

3. The processor of claim 1, wherein the first and second micro-architectures are ARM-based micro-architectures.

4. The processor of claim 1, wherein the first and second operands are used to store first and second IP offsets, and wherein execution of the instruction on the processor core causes a value in the IP of the processor core to be offset by the first IP offset if the processor core corresponds to the first type of processor core or causes the value of the IP of the processor core to be offset by the second IP offset if the processor core corresponds to the second type of processor core.

5. The processor of claim 1, wherein the first and second operands are used to store first and second addresses, and wherein execution of the instruction on the processor core causes the first address to be loaded into the IP of the processor core if the processor core is the first core type of processor core or causes the second address to be loaded into the IP of the processor core if the processor core is the second type of processor core.

6. The processor of claim 1, wherein the instruction is a branch instruction that branches to the first code segment when the branch instruction is executed on the first type of processor core and branches to the second code segment when the branch instruction is executed on the second type of processor core.

7. The processor of claim 6, wherein the branch instruction is a conditional branch instruction that includes a third operand to store data that is evaluated by the processor core when the instruction is executed to determine whether or not to branch to either of the first and second code segments.

8. The processor of claim 1, wherein the instruction is a call instruction that calls the first code segment when the call instruction is executed on the first type of processor core and calls the second code segment when the call instruction is executed on the second type of processor core.

9. The processor of claim 8, wherein the call instruction is a conditional call instruction that includes a third operand to store data that is evaluated by the processor core when the instruction is executed to determine whether or not to call either of the first and second code segments.

10. The processor of claim 1, wherein the processor includes Nor more different types of cores and the ISA includes an instruction that, when executed on one of the processor cores causes the processor to:
read a register containing a location of a table containing information that maps each of the N different types of cores to a location at which a code segment corresponding to that type of core is located; and
retrieve, from the table, the location of the code segment associated with the type of core the processor core executing the instruction is.

11. A method performed by a processor having a plurality of processor cores including at least one first type of processor core implementing a first micro-architecture and at least one second type of processor core implementing a second micro-architecture, the method comprising:
executing an instruction on a processor core to cause the processor core to execute a first code segment if the processor core is the first type of processor core or to execute a second code segment if the processor core is the second type of processor core.

12. The method of claim 11, wherein the processor cores include at least one big core and at least one little core, wherein each of the at least one big core is associated with the first micro-architecture and wherein each of the at least one little core is associated with the second micro-architecture, and wherein a little core consumes less power than a big core.

13. The method of claim 11, wherein the first and second micro-architectures are ARM-based micro-architectures.

14. The method of claim 11, wherein each of the plurality of processor cores includes an instruction pointer (IP), wherein the instruction includes first and second operands used to store first and second IP offsets, and wherein execution of the instruction on the processor core causes a value in the IP of the processor core to be offset by the first IP offset if the processor core is the first type of processor core or causes the value of the IP of the processor core to be offset by the second IP offset if the processor core is the second type of processor core.

15. The method of claim 11, wherein each of the plurality of processor cores includes an instruction pointer (IP), wherein the instruction includes first and second operands used to store first and second addresses, and wherein execution of the instruction on the processor core causes the first address to be loaded into the IP of the processor core if the processor core is the first core type of processor core or causes the second address to be loaded into the IP of the processor core if the processor core is the second type of processor core.

16. The method of claim 11, wherein the instruction is a branch instruction that branches to the first code segment when the branch instruction is executed on the first type of processor core and branches to the second code segment when the branch instruction is executed on the second type of processor core.

17. The method of claim 16, wherein the branch instruction is a conditional branch instruction that includes a third operand to store condition data, further comprising:
evaluating the condition data to determine whether or not to branch to either of the first and second code segments.

18. The method of claim 11, wherein the instruction is a call instruction that calls the first code segment when the call instruction is executed on the first type of processor core and calls the second code segment when the call instruction is executed on the second type of processor core.

19. The method of claim 18, wherein the call instruction is a conditional call instruction that includes a third operand to store conditional data, further comprising:
evaluating the condition data to determine whether or not to call either of the first and second code segments.

20. The method of claim 11, wherein the processor includes Nor more different types of cores, each having a respective micro-architecture, further comprising:
reading a register containing a location of a table containing information that maps each of N different types of cores to a location at which a code segment corresponding to that type of core is located;
retrieving, from the table, the location of the code segment associated with the type of core the processor core executing the instruction is; and
causing the processor core to begin executing that code segment.

21. A non-transitory machine-readable medium having instructions stored thereon comprising a compiler to generate and assembly opcode to be executed on a target processor having a plurality of processor cores including at least one first type of processor core implementing a first micro-architecture and at least one second type of processor core implementing a second micro-architecture, wherein execution on a host machine enables the compiler is enabled to:
identify a block of source code for which respective first and second opcode segments are to be generated, the first opcode segment configured to be executed on the first type of processor core using the first micro-architecture, the second opcode segment configured to executed on the second type of processor core using the second micro-architecture;
generate each of the first and second opcode segments; and
generate an instruction that is part of an instruction set architecture (ISA) for the target processor that, when executed by one of the plurality of processor cores is configured to cause an execution thread of the processor core to jump to either a first instruction in the first opcode segment if the processor core is the first type of processor core or to jump to a first instruction in the second opcode segment if the processor core is the second type of processor core.

22. The non-transitory machine-readable medium of claim 21, wherein the processor cores include at least one big core and at least one little core, wherein each of the at least one big core is associated with the first micro-architecture and wherein each of the at least one little core is associated with the second micro-architecture, and wherein a little core consumes less power than a big core.

23. The non-transitory machine-readable medium of claim 21, wherein the first and second micro-architectures are ARM-based micro-architectures.

24. The non-transitory machine-readable medium of claim 21, wherein the instruction includes first and second operands that are used to store first and second instruction pointer (IP) offsets, and wherein the instruction is configured such that execution of the instruction on the processor core causes a value in the IP of the processor core to be offset by the first IP offset if the processor core corresponds to the first type of processor core or causes the value of the IP of the processor core to be offset by the second IP offset if the processor core corresponds to the second type of processor core.

25. The non-transitory machine-readable medium of claim 21, wherein the instruction includes first and second operands that are used to store first and second addresses, and wherein execution of the instruction on the processor core causes the first address to be loaded into an instruction pointer (IP) of the processor core if the processor core is the first core type of processor core or causes the second address to be loaded into the IP of the processor core if the processor core is the second type of processor core.
